(19) United States
(12) Patent Application Publication
(10) Pub. No.: US 2026/0270538 A1
(43) Pub. Date: Sep. 10, 2026

(54) IMPACT-RESISTANT MICRO-CAMERA FOR HELMET

(71) Applicant: Aaron Brian Leet, Oakdale, MN (US)

(72) Inventor: Aaron Brian Leet, Oakdale, MN (US)

(21) Appl. No.: 19/555,885

(22) Filed: Mar. 3, 2026

Related U.S. Application Data
(60) Provisional application No. 63/766,171, filed on Mar. 3, 2025.

(51) Int. Cl. H04N 23/51; A42B 3/04; H04N 23/60; H04N 23/62; H04N 23/66; H04N 23/667; H04N 23/67; H04N 23/68

(52) U.S. Cl. CPC H04N 23/51; A42B 3/042; H04N 23/62; H04N 23/64; H04N 23/66; H04N 23/667; H04N 23/67; H04N 23/68

(57) ABSTRACT

A micro camera is configured for activity and sport use and for mounting to, or incorporation into, pre-existing sports helmets. The micro camera may be centrally mounted on a front portion of a helmet and/or on a cage or faceguard structure using interchangeable mounting options including screw-based attachment, slot-based attachment, and snap-based attachment. The micro camera includes impact-resistant construction and may include a polycarbonate lens covering. The micro camera incorporates processing and storage circuitry including one or more microchips comprising CPUs, GPUs, DRAM, NAND Flash, ASICs, and/or system-on-a-chip circuitry, and may include a microSD card interface. The micro camera supports continuous auto-focus, vibration or stability control, variable aperture and shutter settings including shutter priority mode, and remote operation via Wi-Fi and/or cloud upload for review and quick editing, including during real-time broadcast.

### PRIORITY CLAIM

The present application claims the benefit of U.S. Provisional Patent Application No. 63/766,171, filed March 3, 2025, and titled “DUNAMIS,” the entire contents of which are incorporated herein by reference.

### TECHNICAL FIELD

The present technology is generally related to wearable imaging systems and, more particularly, to compact cameras configured to be mounted to, or incorporated into, sports helmets to capture video and still images in high-impact, high-motion environments.

### BACKGROUND

Wearable cameras are used to capture first-person and close-proximity views of activities, including athletic events, training, and other motion-intensive use cases. In these environments, a camera may be subjected to rapid motion, vibration, and repeated impacts, while also being expected to provide clear, stable video and still imagery.

Conventional helmet-mounted cameras can be limited in their ability to withstand collisions and high-impact conditions and may have optical elements that are susceptible to damage or degradation. Further, existing mounting approaches may not provide stable, central placement across different helmet types, including helmets having cages or faceguards, and may not provide convenient interchangeability between mount styles.

Certain use cases further benefit from remote operation and prompt transfer of captured content. For example, during real-time broadcast or live event coverage, an operator may desire to remotely trigger capture, adjust capture settings, and promptly review and edit captured content.

Accordingly, there is a need for a compact, impact-resistant micro camera that can be mounted to, or incorporated into, sports helmets using multiple and interchangeable mounting options that enable central placement, and that supports advanced capture, storage, and transfer features suitable for high-impact sports environments.

### SUMMARY OF THE DISCLOSURE

A helmet-mountable micro camera system is disclosed that is configured for activity and sport use and that is capable of being mounted to, or incorporated into, pre-existing sports helmets. In various implementations, the micro camera is configured to be mounted in a central position on a helmet, including on a front portion of the helmet and/or on a cage or faceguard structure of a football or hockey helmet.

In various implementations, the micro camera includes an impact-resistant construction. In some implementations, the micro camera includes an impact-resistant lens covering, such as a polycarbonate covering, that protects one or more lenses and/or an optical opening from impact, collision, and abrasion.

In various implementations, the system includes multiple mounting options that may be interchangeable, including mounting arrangements configured to secure the micro camera via one or more screws, slots, snaps, and combinations thereof. The mounting options may be selected to accommodate different helmet types and mounting locations while maintaining secure attachment during motion and impact.

In various implementations, the micro camera incorporates one or more microchips including integrated circuits such as logic chips (including CPUs and/or GPUs) for processing, memory chips (including DRAM and/or NAND Flash) for storage, ASICs for specialized tasks, and/or system-on-a-chip (SoC) circuitry. In some implementations, the micro camera includes a microSD card interface for removable storage, optionally including dash-camera-like local recording functionality.

In various implementations, the micro camera supports continuous auto-focus, vibration and/or stability control, variable aperture and shutter settings, and a shutter priority mode. The micro camera may be configured for high resolution capture and selected megapixel count and frame rate, and may be configured as a mirrorless camera in some implementations.

In various implementations, the micro camera is configured for remote operation by a remote operator, including during real-time broadcast. Captured content may be transferred via Wi-Fi, via cloud upload, and/or via other transfer mechanisms to facilitate review and quick editing. In some implementations, the micro camera supports optional AI-assist integration for one or more imaging-related tasks.

The details of one or more aspects of the disclosure are set forth in the accompanying drawings and the description below. Other features, objects, and advantages of the techniques described in this disclosure will be apparent from the description and the drawings, and from the claims.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a high-level conceptual diagram of a wireless video-communications system.

FIG. 2 shows a first example implementation of the system of FIG. 1 for athletic-sport competitions.

FIG. 3 is an oblique-perspective view of an example impact-resistant micro-camera for the system of FIGS. 1 and 2, including an example impact-resistant polycarbonate-based lens-protection structure.

FIG. 4 is a functional block diagram of the micro-camera of FIG. 3, including optics, an image sensor, processing circuitry, memory, removable storage, and wireless communication circuitry.

FIG. 5A is an oblique view of another example of the micro-camera of FIG. 3 mounted in a central position on a forehead portion of a sports helmet.

FIG. 5B is an oblique view of another example of the micro-camera of FIG. 3 mounted in a central position on a cage or faceguard structure of the sports helmet of FIG. 5A.

FIG. 5C is a side-profile view of another example of the micro-camera of FIG. 3 mounted to side portion on a cage or faceguard structure of the sports helmet of FIGS. 5A and 5B.

FIG. 6A illustrates a non-limiting example screw-based mounting interface for the micro-camera and sports helmet of FIGS. 5A-5C.

FIG. 6B illustrates a non-limiting example slot-based mounting interface for the micro-camera and sports helmet of FIGS. 5A-5C.

FIG. 6C illustrates a non-limiting example snap-button-based mounting interface for the micro-camera and sports helmet of FIGS. 5A-5C.

FIG. 7A is a partial cutaway view of the sports helmet of FIGS. 5A-5C, showing an example multi-layer impact-resistant structure thereof.

FIG. 7B shows a non-limiting example implementation of the multi-layer impact-resistant structure of the sports helmet of FIG. 7A.

FIG. 8A is an oblique-perspective view of two examples of the micro-camera of FIG. 3 embedded within a football.

FIG. 8B is a cross-sectional side-profile view of the football of FIG. 8A.

FIG. 8C is a partial cutaway diagram of the football of FIGS. 8A and 8B.

FIG. 9 is a flow diagram of a method of capturing and transmitting stabilized video from a spiraling football during use.

FIG. 10 shows an example unmanned aerial vehicle (UAV) or “drone” for the system of FIGS. 1 and 2.

FIG. 11 shows another example implementation of the system of FIG. 1 for law-enforcement and/or military applications.

FIG. 12 shows an example protective helmet of the system of FIG. 10.

While examples of this disclosure are amenable to various modifications and alternative forms, specifics thereof shown by way of example in the drawings will be described in detail. It should be understood, however, that the intention is not to limit the disclosure to the particular examples described.

### DETAILED DESCRIPTION

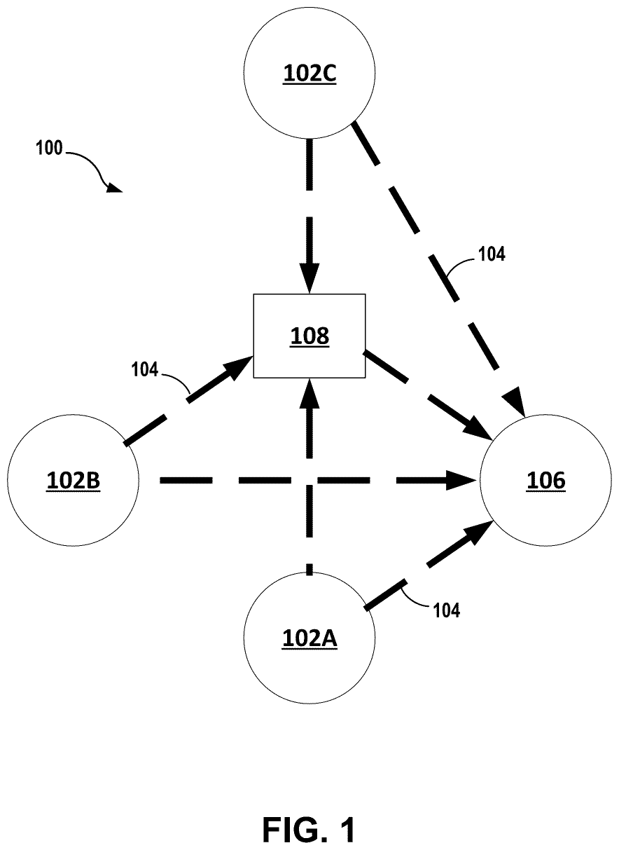

FIG. 1 is a high-level conceptual diagram of a video-communications system 100, in which the various modules are configured to transmit and/or receive video data therebetween. In particular, system 100 includes one or more recording devices 102A-102C, each having at least one customized impact-resistant micro-camera, in accordance with techniques of this disclosure. The recording device(s) 102A-102C are configured to generate (or “capture”) video data 104, and transmit the video data 104 to a receiving device 106, either directly (e.g., via any standardized short-range wireless-communication protocol), or indirectly via an intermediate transceiver device 108 having both reception and transmission functionality. The unique hardware of the impact-resistant micro-cameras, as detailed further below, enables the system 100 to be implemented or deployed in previously inaccessible environments with “extreme” conditions, such as full-contact sports (e.g., football, hockey, etc.), law enforcement and military operations, and more.

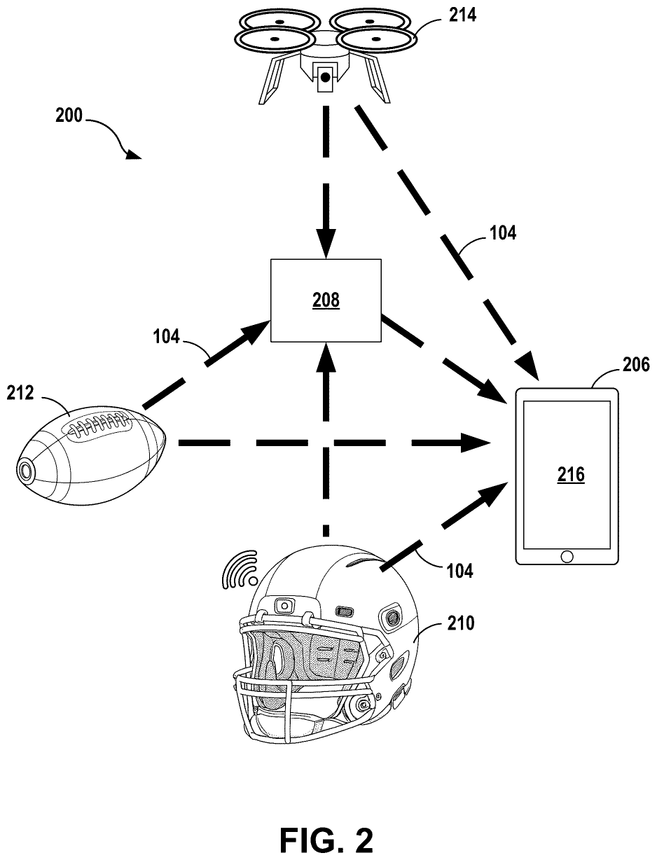

For instance, FIG. 2 shows a first example implementation (200) of the system 100 in a contact-sports environment. The example of system 200 is shown and described throughout this disclosure with respect to the sport of American football, though it should be understood that the same techniques are similarly applicable to other contact sports, such as hockey, rugby, soccer, and the like.

As shown in FIG. 2, the impact-resistant micro-cameras of this disclosure can be incorporated into various articles of equipment associated with an American football game—for instance, the players'protective helmets 210, the game ball 212, and/or a “bird's eye” recording device 214, such as a remote-controlled drone or a cable-suspended camera (commonly known as a “Skycam” or Spidercam”).

Each of these recording devices can then be deployed directly onto (or above) the field-of-play to capture and transmit first-person-video (FPV) data 104 to any number of remote devices. For instance, the FPV data 104 may be transmitted (or “livestreamed”) directly to a user's personal computing device 206 (e.g., smartphone, tablet, laptop, etc.) with a display screen 216 for viewing the video data 104 in real time. Additionally or alternatively, the various recording devices can transmit the video data 104 to a telecommunications network 208 for editing and broadcast.

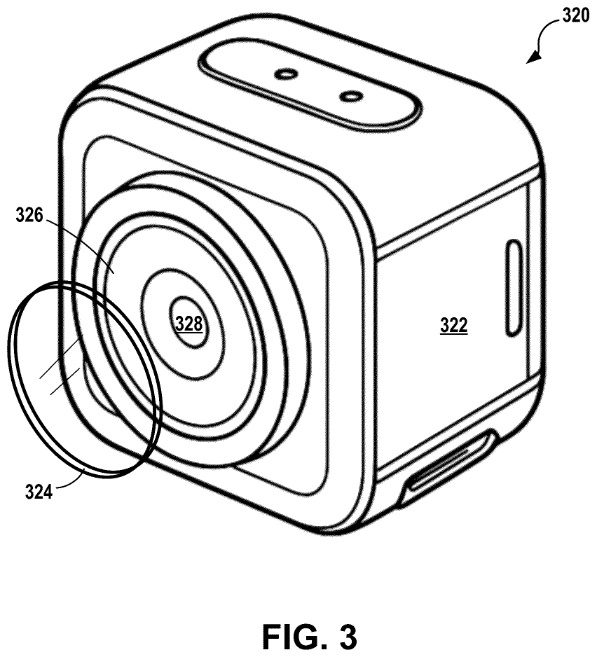

FIG. 3 shows a first, non-limiting example implementation of a custom micro-camera 320 that may be incorporated into the recording device(s) of the systems 100, 200, of FIGS. 1 and 2, respectively. In accordance with the techniques of this disclosure, and across the various implementations described herein, the micro-camera 320 is characterized by its impact-resistant construction, i.e., its durability and resistance to damage even under extreme conditions. This quality of impact resistance may be a feature of any or all of: the selection of materials used for fabrication; the incorporation and design of designated “protective” structures, such as an external housing 322; and the particular arrangement of sub-components into a compact form-factor without extensions or protrusions predisposed to break off from the main structure. In some examples, the external housing 322 may be formed from graphene, or another suitably durable, lightweight material.

In some implementations, the micro-camera 320 includes an impact-resistant lens covering 324 disposed over an optical opening 326 and/or over one or more lenses 328. In such cases, the lens covering 324 is configured to protect optical components (328) from impacts, collisions, and abrasion during sport use. The lens covering 324 may be formed from, or may include, one or more durable, transparent materials such as polycarbonate.

In some implementations, the micro-camera 320 is mirrorless to support a compact form factor suitable for incorporation into an article of sporting equipment, in particular, for mounting onto a protective helmet 210 (as shown and described further below). The reduced size and weight improve the integration of the camera 320 with sports helmets 210, thereby presenting a technical advantage.

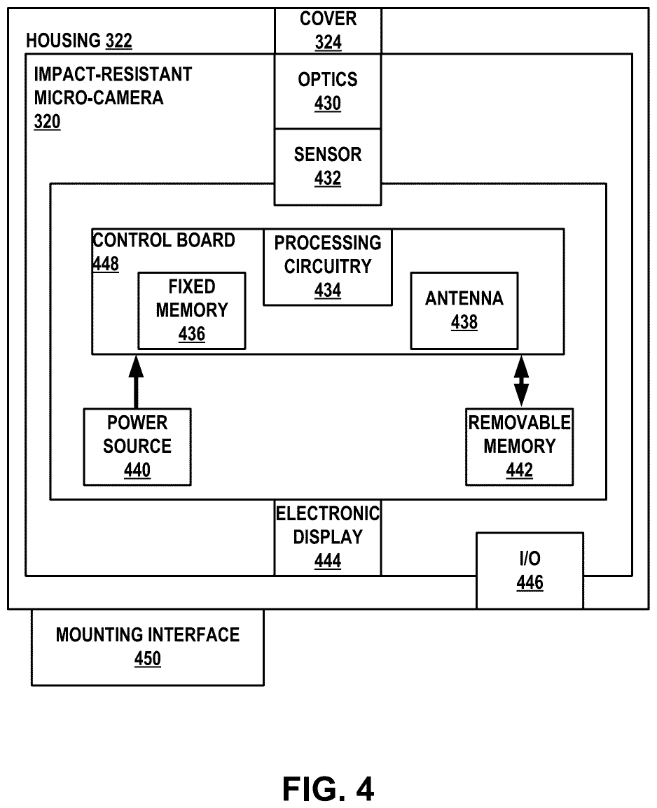

FIG. 4 is a functional block diagram of the micro-camera 320 of FIG. 3, illustrating various example internal components and functional units therein. It is to be readily understood that any such components and functional units may be implemented as hardware, firmware, software, and any combination thereof. In general, the micro-camera 320 includes imaging optics (or “optical components”) 430 (e.g., lens(es)), an image sensor 432, processing circuitry 434, a fixed memory 436, wireless-communication circuitry 438, and a power source 440. Optionally, the micro-camera 320 can include a removable storage device 442 and/or an electronic display screen 444.

In various implementations, the micro-camera 320 includes imaging optics 430 and an image sensor 432 configured to capture video and still images, collectively forming FPV data 104. The micro-camera 320 may be configured for high-resolution capture and user-selected megapixel count and frame rate.

In various implementations, the micro-camera 320 provides continuous auto-focus functionality such that focus can be adjusted during capture of FPV data 104. In various implementations, the micro-camera 320 provides vibration control and/or stability control to reduce image degradation associated with motion, vibration, and/or impacts.

In various implementations, the micro-camera 320 supports variable aperture and shutter settings, including a “shutter priority” mode. In shutter-priority mode, shutter settings may be prioritized relative to other exposure parameters.

In various implementations, the control board (or “motherboard” or “hard drive”) 448 of the micro-camera 320 includes one or more microchips comprising integrated circuits. The microchips may include one or more logic chips 434 (including CPUs and/or GPUs) configured to process image data. The processor 434 can include any suitable fixed-function circuitry or programmable processing circuitry, such as a microprocessor, a controller, a DSP, an ASIC, an FPGA, or equivalent discrete or analog logic circuitry. In some examples, the processor 434 can include multiple components, such as any combination of one or more microprocessors, one or more controllers, one or more DSPs, one or more ASICs, or one or more FPGAs, as well as other discrete or integrated logic circuitry. The functions attributed to the processor 434 herein may be implemented as software, firmware, hardware, or any combination thereof.

The micro-camera 320 may further include memory chip(s) 436 for storage, such as DRAM and/or NAND Flash. In various implementations, the micro-camera 320 includes an ASIC for specialized tasks and/or a system-on-a-chip (SoC) that integrates processing and other functions. The memory 436 can include computer-readable instructions that, when executed by the processor 434, cause the micro-camera 320 to perform various functions. The memory 436 can include volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

In some implementations, the micro-camera 320 includes a microSD-card interface configured to store captured content to a microSD card or other removable-memory device 442. In some implementations, the micro-camera 320 supports local recording functionality that is similar in at least some respects to vehicular-dashboard-camera (or “dashcam”) recording, such as storing captured content locally for subsequent retrieval, review, and/or editing.

In various implementations, the micro-camera 320 includes wireless transceiver circuitry (i.e., antennae) 438 configured transmit and receive commands, enabling the micro-camera 320 to be remotely operated by computing device 206, such as a smartphone, tablet, laptop, or the like. Remote operation of the micro-camera 320 may include, for instance, the remote initiation of video capture and/or still capture and remote selection of one or more capture settings.

In some implementations, remote operation of the micro-camera 320 may occur during real-time (or “livestream”) broadcast of FPV data 104. The micro-camera 320 may include a wireless communication module 438 configured to transfer captured video content 104 via a standard wireless-communication protocol, such as wireless telemetry, mixed band, Wi-Fi, Bluetooth, Bluetooth Low Energy, or the like. Additionally or alternatively, captured data 104 may be transferred via cloud upload and/or other data-transfer mechanisms. In various implementations, the transferred content 104 is made available for review and quick editing by the remote operator or other personnel.

In some implementations, the micro-camera 320 optionally supports Artificial-Intelligence (AI)-assist integration for one or more imaging-related tasks, such as assisting with capture settings, stabilization, focus behavior, or other capture-related operations.

In some examples, the micro-camera 320 includes various sub-modules or engines, each of which is constructed, programmed, configured, or otherwise adapted to autonomously carry out a particular function or set of functions. The term “engine” as used herein is defined as a real-world device, component, or arrangement of components implemented using hardware, such as by an application specific integrated circuit (ASIC) or a field-programmable gate array (FPGA), or as a combination of hardware and software, such as by a microprocessor system and a set of associated program instructions that adapt the engine to implement the particular functionality, which (while being executed) transform the microprocessor system into a special-purpose device. An engine can also be implemented as a combination of the two, with certain functions facilitated by designated hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-to-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engine, each of which can be regarded as an “engine” in its own right. Moreover, in examples described herein, each of the various engines corresponds to a defined autonomous functionality, however, it should be understood that, in other contemplated examples, each functionality can be distributed across more than one engine. Likewise, in other contemplated examples, multiple defined functionalities may be implemented by a single engine that performs those multiple functions, possibly alongside other functions, or distributed differently among a set of engines than specifically illustrated and described herein.

The power source 440 is configured to deliver operating power to the components of the micro-camera 320. The power source 440 can include a battery and a power-generation circuit to produce the operating power. In such examples, the battery is rechargeable to allow extended operation. The power source 440 can include any of a plurality of different battery types. In some examples, the power source 440 additionally includes an external power-supply port.

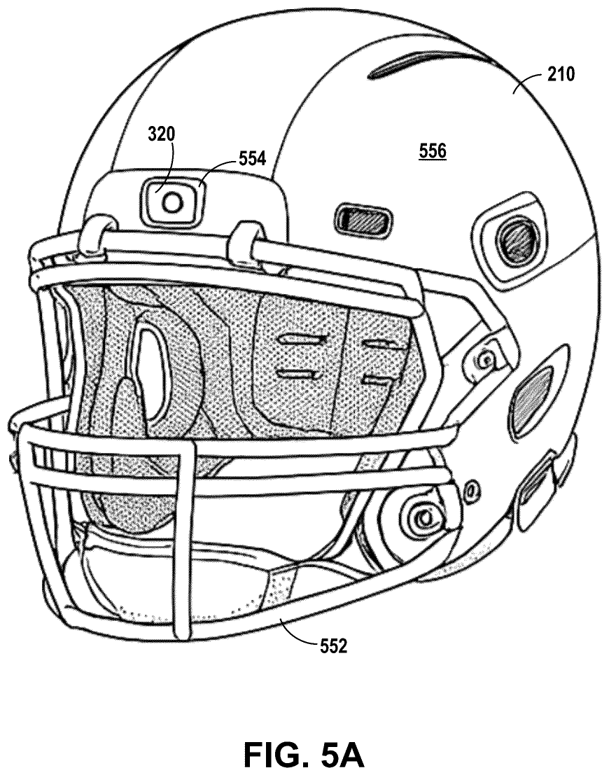

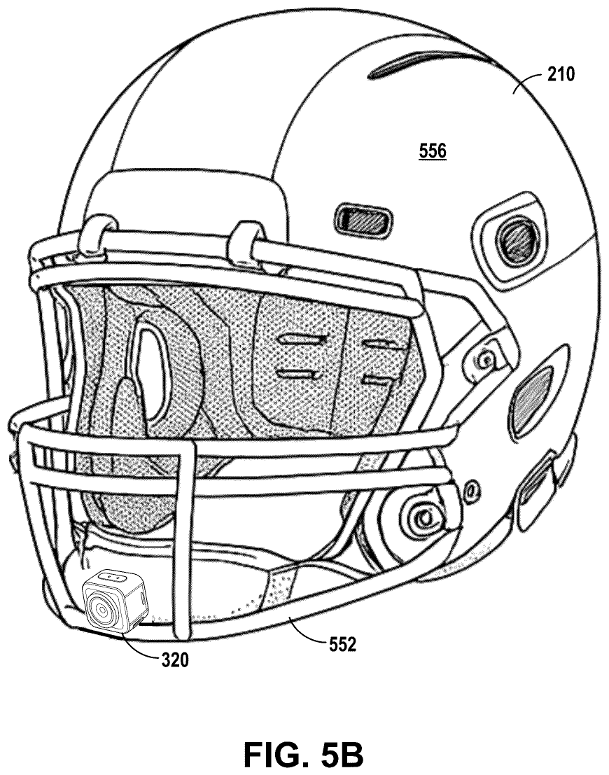

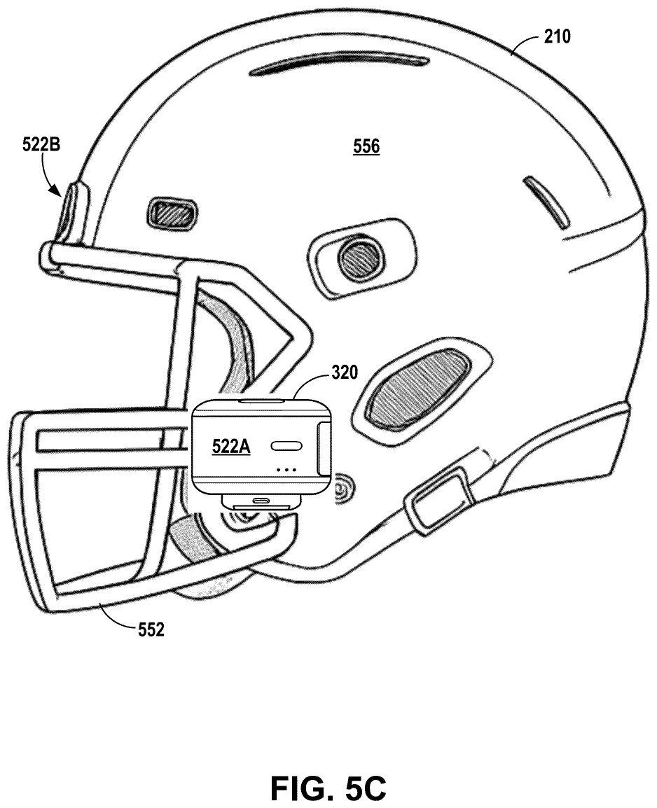

In various implementations, the micro-camera 320 includes a mounting interface 450 for affixing or removably coupling the micro-camera 320 to a piece of equipment, such as a football helmet 210, to convert the equipment into a recording device 102. In some such implementations, the micro-camera 320 may be received within a recess, cavity, or designated housing portion of the helmet 210. One or more surfaces of the micro-camera 320 may be aligned with or protected by the helmet structure 210, while the optical opening 326 remains positioned to capture FPV data 104. For instance, FIG. 5A depicts the micro-camera 320 mounted in a central position on a forehead portion of a sports helmet 210; FIG. 5B depicts the micro-camera 320 mounted in a central position on a cage or faceguard structure 552 of the sports helmet 210; and FIG. 5C depicts the micro-camera 320 mounted to side portion on the cage or faceguard structure 552 of the sports helmet 210. Central placement may include mounting on a front portion of the helmet shell (FIG. 5A) and/or mounting on a cage or faceguard structure 552 (FIG. 5B). Central placement (FIGS. 5A and 5B) can provide a desirable point-of-view and can improve stability relative to off-center mounting (FIG. 5C).

In some implementations, the micro-camera 320 includes an external housing 322 that is configured to be removably coupled to the faceguard 552 of the helmet 210. The housing 322 may define a receptacle sized to receive at least a portion of the micro-camera 320 and may include an opening aligned with an optical axis of the micro-camera 320. In certain implementations, the housing 322 includes one or more engagement features 450 configured to snap onto one or more bars, wires, or ribs of the faceguard 552 to thereby position the micro-camera 320 in a central position relative to a forward viewing direction of a wearer. The engagement features 450 may include, for example, resilient arms, clips, detents, hooks, latches, interference-fit structures, and combinations thereof.

Additionally or alternatively, the camera housing 322 may be configured to fasten to the faceguard 552 using one or more fasteners. By way of example and not limitation, the mounting interface 450 of the external housing 322 may include one or more apertures or threaded bosses configured to receive screws, bolts, rivets, pins, or other fasteners, and/or may include one or more tie slots configured to receive ties, straps, or bands to secure the housing 322 to the faceguard 552. In some implementations, the camera housing 322 and/or the mounting interface 450 includes one or more anti-rotation features configured to resist rotation of the micro-camera 320 relative to the faceguard 552, including keyed interfaces, flats, ribs, or interlocking geometries that engage corresponding features of the faceguard 552.

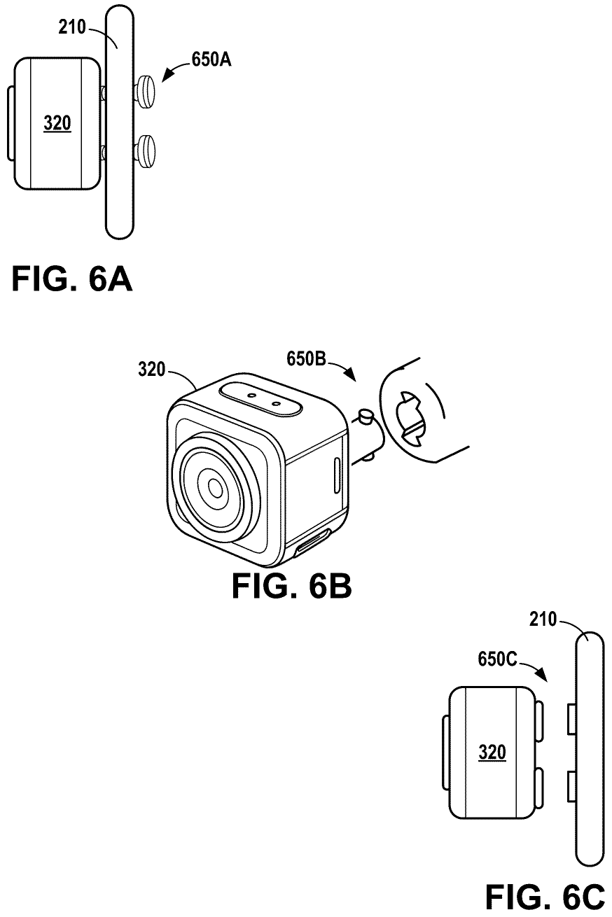

In general, the mounting interface(s) 450 are configured to maintain secure attachment under vibration and impact conditions associated with sport use. FIGS. 6A-6C show three non-limiting examples of mounting interfaces 450 for removably coupling external housing 322 of the micro-camera 320 to the sports helmet 210 of FIGS. 5A-5C. In various implementations, the various mounting interfaces 450 may be functionally equivalent and interchangeable to accommodate different helmet types and mounting locations. Example mounting interfaces 450 include, without limitation: a screw-based mount configured to secure the micro-camera's housing 322 to a helmet structure using one or more fasteners (FIG. 6A); a slot-based mount, such as a bayonet-type locking mechanism, configured to engage a slot, channel, or keyed feature to resist translation and/or rotation (FIG. 6B); and a snap-button-based mount configured to engage one or more snap features to provide a quick-attach and quick-release connection (FIG. 6C).

In other examples, the micro-camera 320 may be rigidly integrated into the helmet 210 instead of being removably coupled. For example, the outer shell 556, the faceguard 552, or another structure of the helmet 210 may include a recess, cavity, pocket, or molded housing portion configured to receive the micro-camera 320 at least partially therein. In such “integrated” configurations, at least a portion of the micro-camera 320 may be flush with, or recessed relative to, an exterior surface of the helmet 210 to reduce protrusion and to improve impact resistance. The integrated configuration may further include a protective cover, bezel, or lip 554 (FIG. 5A) disposed around the optical opening 326. In certain implementations, the helmet structure includes a replaceable insert, cartridge, or module that carries the micro-camera 320 and that is configured to be inserted into and removed from the helmet 210 without permanent modification to the helmet.

In some implementations (such as the example shown in FIG. 5C), the camera 320 may include multiple different interchangeable housings 322, including: (1) a faceguard-mountable housing 522A configured to removably couple (e.g., snap or fasten) to the faceguard 552, and (2) a helmet-integrated housing 522B configured to be received within a recess of the helmet 210, such that the same micro-camera 320 can be deployed across different helmet types and mounting locations while maintaining a central placement and a stable forward field of view.

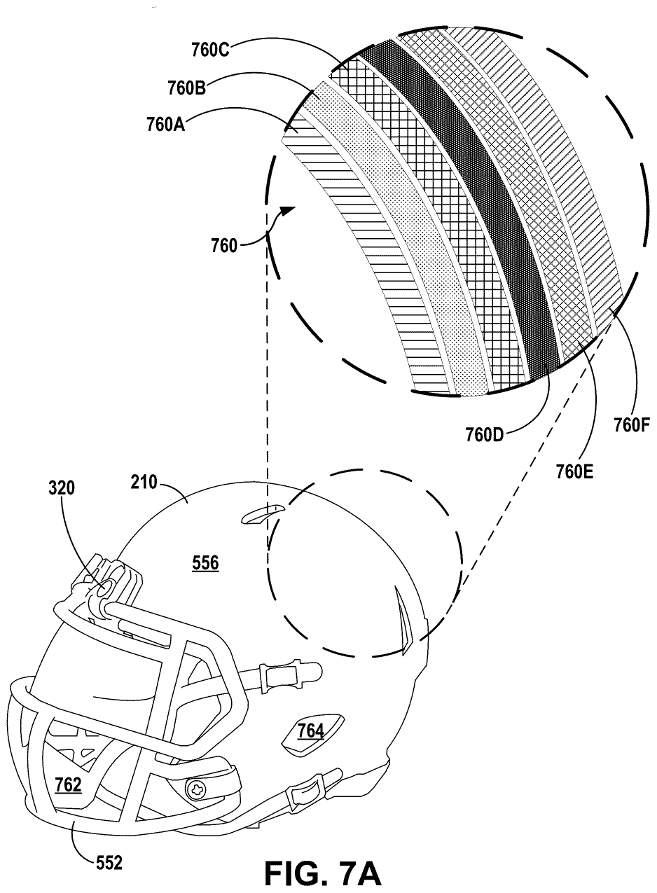

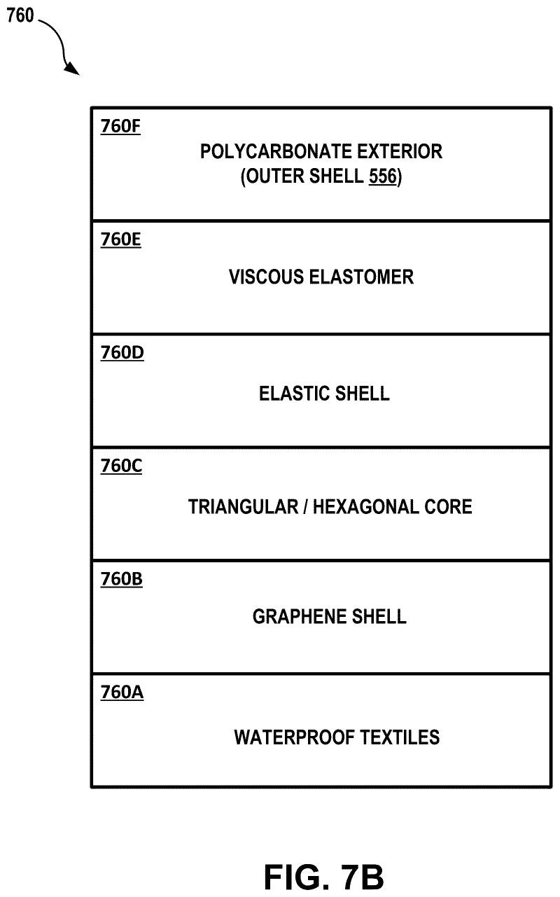

In examples in which the micro-camera 320 is mounted to or integrated within a protective helmet 210, the overall impact resistance of the micro-camera 320 further depends upon the impact resistance of the helmet 210 itself. Accordingly, FIGS. 7A and 7B illustrate an example of the helmet 210 with a multi-layer impact-resistant structure 760. In particular, the multi-layer structure 760 includes at least six nested layers 760A-760F of distinct compositions, mutually arranged in a particular order to substantially increase the impact resistance of the helmet 210.

FIG. 7B illustrates one non-limiting example set and arrangement of such materials, though it should be understood that alternative materials having similar or identical physical properties may be substituted without departing from the scope of this disclosure. In the example of FIG. 7B, a first, innermost layer 760A (i.e., the layer directly adjacent to the player's scalp) includes a vacuum-formed or injection-molded, ventilated (i.e., perforated, channeled, and/or waterproof) textile that may be sectioned in order to wick away the player's perspiration. Additionally or alternatively, innermost layer 760A can include a “memory” type foam or a gel infused material for a comfortable custom fit. In some examples (but not all examples), the innermost layer 760A is removable from the helmet 210 for discarding and replacement. In some examples, the innermost layer 760A layer may be digitally customized such that the interior surface physically conforms to the exterior contour of the player's scalp.

Directly adjacent the innermost layer 760A is a second layer 760B configured for maximum impact-resistance. For instance, the second layer 760B may be formed from an extremely durable, lightweight material such as graphene or a graphene-reinforced material (e.g., polycarbonate or plastic).

Adjacent the second layer 760B is a third layer 760C configured as the structural “core” of the helmet 210. For instance, the third layer 760C may include a row or row(s) of triangular or hexagonal-shaped pieces of material such as graphene or a graphene-reinforced material, Dyneema (e.g., capable of withstanding up to 570,000 PSI), or Zylon (e.g., capable of withstanding up to 830,000 PSI). Adjacent the third layer 760C is a fourth layer 760D. The fourth layer 760D may include, for instance, a “lode” elastic shell utilizing the same or similar materials as the third layer 760C and/or the same shapes but in smaller discrete units. Adjacent the fourth layer 760D is a fifth layer 760E formed from a viscous elastomer, i.e., capable of elastically deforming and then returning to its original shape. Adjacent the fifth layer 760E is an outermost sixth layer 760F (e.g., outer shell 556) consisting of polycarbonate and, in some examples, aluminum.

In some examples (but not all examples), one or more of the layers may be imbued with a contact indicator or pressure indicator, such as a coating of dye and/or an array of sensors. The contact or pressure indicator(s) are configured to identify particular regions of repetitive or continuous impact, in order to bolster future research and development toward the reduction or elimination of concussions, Traumatic Brain Injuries (TBIs), CTE, etc.

The helmet's chinstrap 762 can be removably coupled to the helmet 210 via a ratchet or quick-release mechanism, a traditional stationary snap button, an integrated retention system at specific points, or rigidly fixed within the interior of the helmet 210. The chinstrap 762 can be composed of nylon or a similar strong, elastic material and incorporate a polycarbonate, Kevlar, and/or carbon fiber central cup for the player's chin. The chin cup can contain the same moisture-wicking foam or gel material used in the innermost layer 760A, and can be vacuum-formed or injection-molded.

The helmet's faceguard 552 can be formed from plastic, a rubber-coated metal, or metal reinforced using any of the materials listed above. In some examples (but not all examples), the helmet 210 further includes an integrated impact-resistant earpiece and microphone paired for on-field wireless communication amongst the players and the coaches of a common team. For instance, the earpiece can be incorporated into the helmet 210 adjacent the ear hole or vent 764, while the microphone can be affixed to or integrated within the faceguard 552. In some such examples, the helmet can further include a set of user-input devices (e.g., buttons) such as a “Volume Up” button, a “Volume Down” button, and/or a “Mute” button.

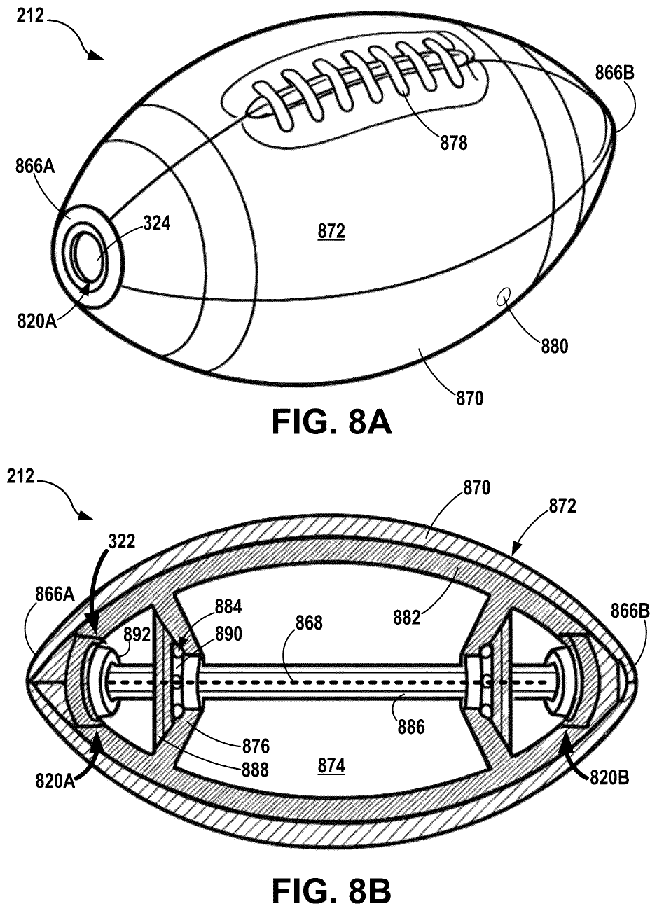

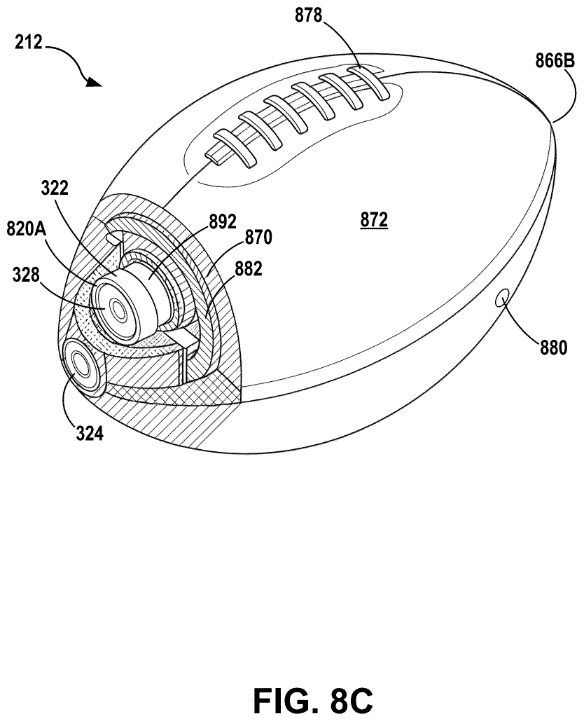

FIGS. 8A-8C illustrate an example implementation of the football 212 of the video system 200 of FIG. 2. As shown, the football 212 includes a pair of impact-resistant micro-cameras 820A, 820B (e.g., micro-camera 320 of FIG. 3) embedded within the opposing “polar” ends 866A, 866B, of the football 212. As used herein, the terms “football,” “sports ball,” and “sports projectile” include an American football and may include similarly shaped or similarly used projectiles. The “longitudinal axis” refers to the axis 868 (FIG. 8B) extending generally between opposite pole regions 866 of the ball 212. “Pole region” refers to a region 866A, 866B at or near an end-tip or nose area of the ball 212.

As shown in FIGS. 8A-8C, the football 212 includes a main body 870 defining an outer aerodynamic surface 872. In the illustrated embodiment, a first impact-resistant micro-camera 820A is integrated at a first pole region 866A, and a second impact-resistant micro-camera 820B is integrated at a second pole region 866B opposite the first pole region 866A.

In other examples, the ball 212 includes only one micro-camera 820, and the opposite pole region 866 includes a counterweight or balancing structure configured to preserve a desired mass distribution and center of mass. Still other configurations may be include a plurality of (e.g., more than two) micro-cameras 820 arranged to provide a wide field-of-view.

The ball's main ball body 870 may include a bladder, carcass, laces, panels, seams, and/or an internal structure consistent with a regulation-type American football, provided that the internal cavity 874 is configured to house at least a portion of the micro-camera(s) 820. The main body 870 may be formed from leather, synthetic leather, polymeric materials, composite materials, or combinations thereof. In some examples, the main body 870 further includes an internal housing structure 876 formed from strong, lightweight material(s) such as carbon fiber, aluminum alloys, hardened steel, magnesium, and/or graphene-based materials.

In some examples, the sports ball 212 is a regulation-compliant-type American football configured for organized play. In such embodiments, the main body 870 is configured to satisfy at least one set of official football specifications and/or playing-equipment requirements promulgated by a sanctioning body, including, without limitation, the National Football League (NFL), the National Collegiate Athletic Association (NCAA), and the National Federation of State High School Associations (NFHS). For instance, the main body 870 may be configured such that one or more aspects or metrics of the ball 212—including its external profile, length along axis 868, long and short circumferences, mass, inflation pressure, the texture of the outer surface 872, panel and seam configuration, and/or grip features (including laces 878) conform to the applicable sanctioning-body specification.

Preferably, the micro-camera(s) 820 are integrated such that the outer aerodynamic surface 872 remains substantially continuous and the mass distribution maintains a desired center of mass and moment of inertia suitable for throwing, spiraling, catching, and kicking in a manner consistent with a regulation football.

In certain embodiments, the main body 870 includes an inflation valve 880 and an internal bladder 882 configured to be inflated to an internal pressure that complies with an applicable sanctioning-body specification, including, without limitation, an inflation pressure specified by the NFL, NCAA, and/or NFHS. In some embodiments, the sports ball 212 includes a pressure indicator and/or a pressure sensor (not shown) configured to indicate whether the internal pressure is within a permitted pressure range, and the internal components are arranged such that the inflation valve 880 remains serviceable without compromising sealing or structural support 876 for the micro-camera(s) 820.

Each micro-camera 820 is positioned within a protective housing 322 (FIG. 3). The camera module 820 includes a lens assembly 430 (or other relevant optical components), an image sensor or detector 432, and processing circuitry 434 configured to locally compress and/or otherwise process the captured FPV data 104. The housing 322 includes an impact-resistant lens cover 324 aligned with the lens assembly 328. The lens cover 324 may be polycarbonate, sapphire, chemically strengthened glass, acrylic, and/or another transparent and impact-resistant material. In certain embodiments, the exterior surface of the lens cover 324 is formed as a convex dome, in order to reduce aerodynamic disturbance and to distribute impact loads imparted thereupon. The lens cover 324 may be flush, recessed, or slightly protruding relative to the ball's exterior surface 872, provided that designated safety and aerodynamic constraints are met. In some embodiments, the camera assembly 820 is configured such that an exterior portion is substantially flush with the ball's outer surface 872, thereby reducing drag and preserving throw and catch characteristics.

The housing 322 may include sealing structures 892 such as gaskets, O-rings, adhesives, or over-molded interfaces, to inhibit ingress of water, dirt, and sweat. The housing 322 may further include shock isolation elements, such as elastomeric rings, compliant mounts, or foam structures, configured to reduce peak acceleration transmitted to the camera module 820 upon impact.

The camera module 820 may include an autofocus actuator, variable aperture (where applicable), shutter control, and configurable settings including frame rate, resolution, exposure mode, shutter-priority mode, and still image capture. The camera module 820 may be configured as a mirrorless architecture and may capture video and still images, collectively forming FPV data 104.

In some examples, each micro-camera 820 further includes a bearing assembly 884 configured to permit relative rotation between the ball body 870 and the camera module 820. In one embodiment, the bearing assembly 884 defines a rotational interface about the longitudinal axis 868 such that, as the ball's main body 870 rotates during a spiral throw, the camera module 820 remains substantially non-rotating or rotates at a substantially reduced angular velocity relative to the surrounding environment. The bearing assembly 884 may be configured for low friction and high impact-resistance, including preloaded bearings and reinforced races. For instance, the bearing assembly 884 may include one or more radial bearings and one or more thrust bearings. The bearing elements may be or may include: ball bearings, roller bearings, needle bearings, magnetic bearings, and/or fluid bearings.

The bearing assembly 884 may be integrated into a ring structure 888 functionally coupled to the ball body 870/882, and a hub structure 890 coupled to the camera's housing 322. The ring structure 888 and hub structure 890 cooperate to enable the relative rotation while maintaining alignment of the lens cover 324 with the ball's outer surface 872.

Optionally, a shaft, rod, or spindle 886 may extend along the longitudinal axis 868 to support the micro-camera(s) 820 and/or to couple the first micro-camera 822A to the second micro-camera 822B. In some examples, the shaft 886 provides structural support and alignment. In other embodiments, the bearing assembly 884 and housing geometry provide sufficient support without a shaft 886. In certain examples, each micro-camera 820 includes an omni-directional bearing system such that limited multi-axis compliance is provided to address off-axis impacts and to maintain optical alignment.

In some examples, the ball 212 includes one or more stabilization subsystems, alone or in combination. For instance, in a first example stabilization approach, in-body image stabilization (IBIS) shifts the image sensor 432 along multiple axes, including translations along X and Y and rotations including roll, pitch, and yaw, to counteract motion. In a second example approach, optical image stabilization (OIS) adjusts one or more lens elements of the lens assembly 430. IBIS and OIS may be used together.

In a third example approach, a motorized gimbal supports the camera module 820 or a sensor subassembly and uses one or more motors to stabilize pan, tilt, and roll in response to feedback from an inertial measurement unit (IMU). The IMU may include gyroscopes and accelerometers.

In a fourth example approach, electronic image stabilization (EIS) is performed by a processor that analyzes successive frames, estimates motion, and warps, aligns, or crops frames to produce stabilized output. In certain embodiments, EIS functions as a digital gimbal.

The stabilization subsystem may cooperate with the bearing assembly 884. For example, the bearing assembly 884 may reduce high-rate roll associated with spiral spin, while IBIS, OIS, gimbal stabilization, and/or EIS address residual motion, impact impulses, and non-axial disturbances.

The micro-cameras 820 may include any or all of the same components discussed above with respect to FIG. 4, including processing circuitry 434 (including one or more CPUs, GPUs, ASICs, or SoCs), fixed memory memory 436 (including volatile memory and non-volatile memory), and storage 442, including removable storage such as a microSD card. The electronics 448 may implement compression, encoding, buffering, and metadata tagging (including timestamps and IMU-derived orientation data).

The football 212 may include communications circuitry 438 configured to communicate captured content to an external device 206/208, including a handheld controller, a sideline receiver, a broadcast unit, a network gateway, and/or cloud infrastructure. The communications circuitry 438 may include any suitable communications interface(s), whether presently known or later developed, and may support one or more wired and/or wireless links. By way of example, the communications circuitry 438 may support radiofrequency communications (including Wi-Fi, Bluetooth, ultra-wideband, and cellular), satellite communications, near-field communications, mesh networking and relay-based communications, and other protocols. In certain embodiments, the ball 212 communicates a live stream during play; in certain embodiments, the ball 212 stores captured content locally and transfers the content after play by a short-range link or a wired interface.

A remote operator may control capture during play, including initiating or ending recording, triggering still images, changing exposure parameters, selecting a camera (front, rear, or both), and selecting stabilization modes. In some embodiments, AI-assist processing is provided by the processor(s) 434 and/or by the external device(s) 206/208, and is configured to perform functions such as horizon leveling, subject tracking, highlight detection, automatic clip generation, and/or selection of frames of interest.

The ball's camera(s) 820 include a power subsystem 440 including a battery and power management circuitry. The ball 212 may include a wired charging port, sealed contacts, or an inductive charging coil. In some embodiments, the ball 212 includes energy harvesting circuitry, such as vibration-based harvesting, to extend operation time.

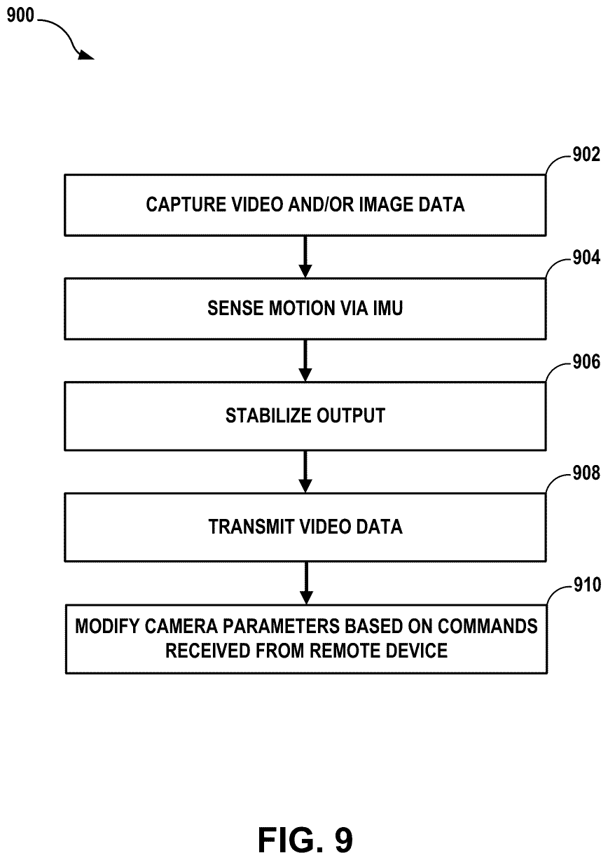

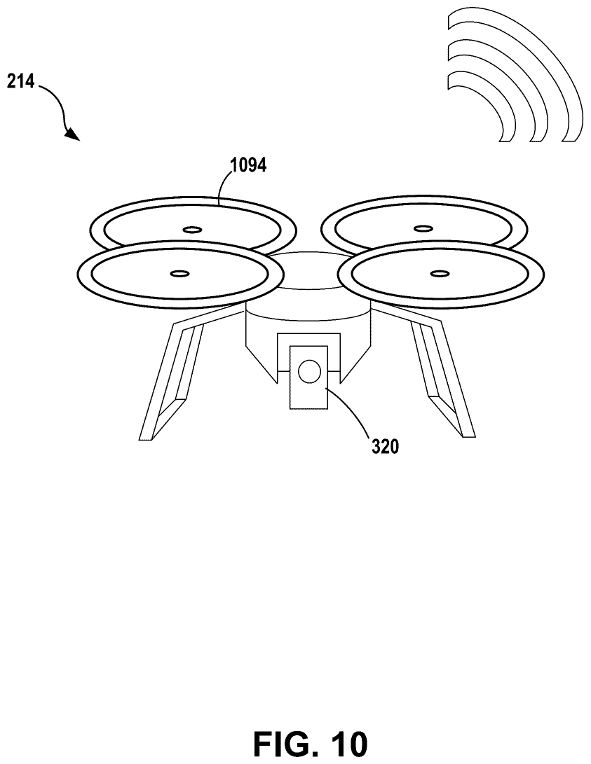

FIG. 9 is a flow diagram 900 of a method of capturing and transmitting stabilized video from a spiraling football 212 during use. The method includes, at Step 902, capturing video and/or still images 104 from a camera module 820 integrated into a football 212 during handling and flight, wherein the camera 820 is mechanically decoupled from the rotation of the ball 212 via a bearing assembly 884. The method further includes, at Step 904, sensing motion using an IMU, and at Step 906, stabilizing output using one or more of IBIS, OIS, gimbal stabilization, and EIS. The method further includes, at Step 908, transmitting a livestream and/or uploading content to a remote device or cloud service. Finally, the method optionally includes, at Step 910, receiving commands from a remote device to control camera parameters in real-time during the broadcast.

FIG. 10 shows an example unmanned aerial vehicle (UAV) or “drone” 214 of the system 200 of FIG. 2, wherein the drone 214 includes an integrated impact-resistant micro-camera 320 (e.g., micro-camera 320 of FIG. 3). The drone 214 can include self-contained or separate rotary blades 1094. The blades 1094 may be reinforced with a lightweight, durable material such as graphene, Kevlar, carbon fiber, or another material (as described above). The drone 214 can include wireless receiving and wireless transmission functionality (e.g., Wi-Fi, Bluetooth, etc.), and may function as an intermediary data transmission device such as a modem/router, a repeater/extender, etc. In some examples, the drone 214 includes photovoltaic cell (“PVC”) technology, such as Dyesol, to extend its functional lifespan between plugged-in charging cycles. During a football game or other athletic event, the drone could be piloted, programmed, or AI-driven to seek out the best vantage point from which to capture video data 104 of the gameplay below.

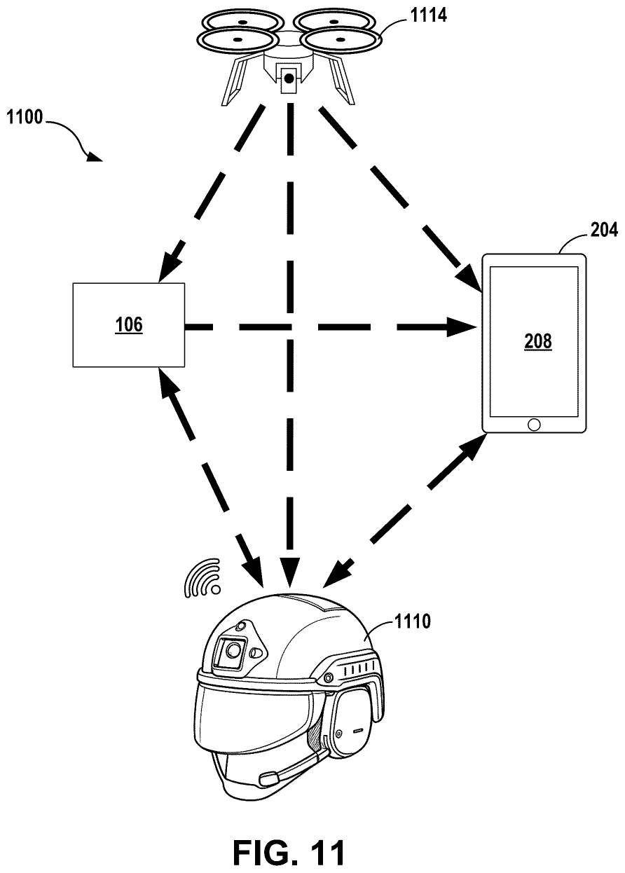

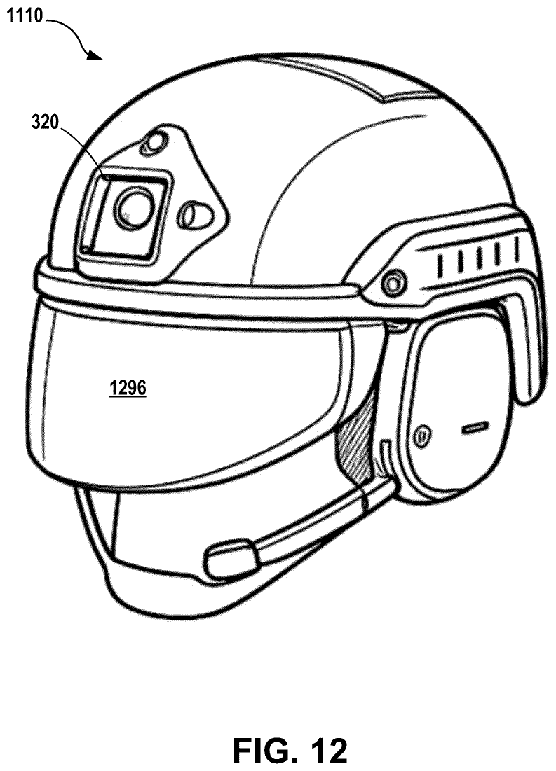

FIG. 11 shows another example implementation (1100) of the system 100 of FIG. 1. The system 1100 of FIG. 11 may also be considered to be an alternate example of the system 200 of FIG. 2, sharing common components, functions, and attributes, other than where explicitly noted herein. Specifically, whereas system 200 of FIG. 2 is configured to be deployed for athletic competitions, system 1100 of FIG. 11 is tailored for law-enforcement and/or military applications. Nevertheless, both systems share a number of identical, similar, and/or analogous features. For instance, both systems 200 and 1100 are configured to include a respective protective helmet 210/1110 having an impact-resistant micro-camera 320 removably coupled thereto or rigidly integrated therein. Similarly, both systems 200/1100 are configured to include an overhead, “bird's eye” recording device, such as a surveillance drone 214/1114. In the military system 1100, but not the athletic system 200, the drone 1114 may additionally include certain defensive and/or offensive capabilities, such as weaponry. However, both drones 214/1114 may include additional technology such as infrared or night-vision camera(s), geolocation (e.g., GPS) functionality or other spatial tracking, and/or inertial measurement units (IMUs) to facilitate position and orientation calculations.

FIG. 12 shows an example of the protective helmet (or “combat helmet”) 1110 of the system 1100 of FIG. 11. The tactical combat helmet 1110, with military, SWAT, and other practical applications, may be substantially similar in construction to the football helmet 210—for instance, including a multi-layer construction of the kind described in FIGS. 8A and 8B. Additionally or alternatively, the combat helmet 1110 may include an anti-glare coating or material (e.g., Kevlar, carbon fiber, graphene, etc.), may incorporate photovoltaic cell (“PVC”) technology, and may include a full or partial retractable visor 1296 that slides into the helmet 1110. The visor 1296 may be manufactured from a bulletproof or ballistic-resistant glass material (e.g., solid acrylic, laminated polycarbonate, glass-clad polycarbonate), and may include a polarized or anti-glare outer coating. In some examples, the visor 1296 may include an integrated Heads-Up Display (HUD), in which case the combat helmet 1110 constitutes both a video-recording device 102 and a video-receiving device 106. The helmet 1110 may be configured to digitally interface with certain law-enforcement databases (e.g., FBI, CIA, etc.) to help identify potential threats, targets, suspects as would then be presented on the HUD of the visor 1296. The impact-resistant camera 320 may also be covered by a bulletproof or ballistic-resistant glass material, such as solid acrylic, laminated polycarbonate, or glass-clad polycarbonate, and could incorporate infrared and night-vision technology. As described above with respect to the football helmet 210, the combat helmet 1110 may also include an earpiece and microphone, or equivalently, a dual-function device having both audio-input and audio-output functionality. Additional optional features include: a wirelessly-paired surveillance drone 1114; a high-intensity strobe light for emergency acquisition, distraction, etc.; an integrated tracking device akin to an Apple AirTag; and an integrated lighting system enabling the uses to communicate via code (e.g., via Morse code or color-based signals) when radio-communication is not permitted or not feasible.

It should be understood that individual steps of the previous examples may be performed in any suitable order and/or simultaneously, as long as the overall technique remains operable. Similarly, various aspects disclosed herein may be combined in different combinations than those explicitly presented in the description and accompanying drawings. Additionally, certain aspects of this disclosure described as being performed by a single module or unit (e.g., for clarity) may also be performed by a combination of units or modules associated with an impact-resistant micro-camera 320 or any of various devices incorporating such a camera therein.

The techniques described herein may be implemented in hardware, software, firmware, or any suitable combination thereof. If implemented in software, the functions may be stored as instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital-signal processors (DSPs), general-purpose microprocessors, application-specific integrated circuits (ASICs), field-programmable logic arrays (FPGAs), or other equivalent integrated or discrete-logic circuitry. Accordingly, the term “processor” as used herein may refer to any of the foregoing structures or any other physical structure suitable for implementation of the described techniques, such as circuits or logic elements.

What is claimed is:

1. A method of operating an impact-resistant, helmet-mountable micro-camera, the method comprising:
mounting the micro-camera in a central position on a sports helmet via a mounting interface;
capturing video data using an image sensor of the micro-camera during a sport activity;
applying continuous auto-focus and vibration control or stability control while capturing the video data; and
remotely operating the micro-camera by a remote operator and wirelessly transmitting the video data to a remote computing device for viewing and editing.

2. The method of claim 1, wherein the mounting interface comprises a screw-based attachment, a slot-based attachment, or a snap-based attachment.

3. A system comprising:
a protective helmet; and
a micro-camera comprising:
a housing comprising a mounting interface for removably coupling the micro-camera to the protective helmet;
an image sensor configured to capture first-person video (FPV) data;
processing circuitry comprising at least one microchip configured to process the FPV data, the at least one microchip comprising a CPU, a GPU, an ASIC, or a system-on-a-chip (SoC);
a memory configured to store the FPV data, the memory comprising DRAM or NAND Flash;
a removable-storage interface; and
a wireless-communication module configured to:
receive digital commands from a remote operator, wherein the commands, when executed by the processing circuitry, enable the remote operator to control one or more video-capture parameters of the micro-camera; and
wirelessly transmit the FPV data to the remote operator for review.

4. The system of claim 1, wherein the mounting interface comprises a screw-based attachment, a slot-based attachment, or a snap-button-based attachment.

5. The system of claim 1, wherein the removable-storage interface comprises a microSD-card interface.

6. The system of claim 3, wherein the mounting interface is configured to mount the micro-camera to a faceguard structure of the protective helmet.

7. The system of claim 3, wherein the mounting interface is configured to mount the micro-camera on a front portion of the protective helmet.

8. The system of claim 3, wherein the micro-camera further comprises:
an optical opening; and
an impact-resistant lens covering disposed over the optical opening.

9. The system of claim 8, wherein the impact-resistant lens covering comprises polycarbonate.

10. The system of claim 3, wherein the processing circuitry of the micro-camera is configured to execute a auto-focus module to continuously adjust one or more parameters of a lens or aperture of the micro-camera to increase an image resolution of the FPV data.

11. The system of claim 3, wherein the micro-camera is further configured to perform automatic vibration control or stability control during capture of the FPV data.

12. The system of claim 3, wherein the micro-camera is further configured to receive user input to control a variable-aperture setting and a variable-shutter setting.

13. The system of claim 12, wherein the micro-camera is configured to operate in a “shutter priority” mode.

14. The system of claim 3, wherein the wireless-communication module is configured to wirelessly transmit the FPV data to the remote operator via Wi-Fi.

15. The system of claim 3, wherein the wireless-communication module is configured to wirelessly transmit the FPV data to to a cloud-based server.

16. The system of claim 3, wherein the micro-camera supports an AI-assist integration.

17. The system of claim 3, wherein the micro-camera comprises a mirrorless construction.

18. The system of claim 3, wherein the protective helmet comprises an American football helmet.

19. The system of claim 3, wherein the protective helmet comprises an ice-hockey helmet.

20. The system of claim 3, wherein the protective helmet comprises a military or law-enforcement combat helmet.
